(19) United States
(12) Patent Application Publication
(10) Pub. No.: US 2020/0186625 A1
(43) Pub. Date: Jun. 11, 2020

(54) PROTOCOL CONVERSION APPARATUS, MESSAGE RELAY METHOD, AND PROGRAM

(71) Applicant: NEC CORPORATION, Tokyo (JP)

(72) Inventors: Ayako NAKAO, Tokyo (JP); Junichi KIMURA, Tokyo (JP)

(73) Assignee: NEC CORPORATION, Tokyo (JP)

(21) Appl. No.: 16/625,084

(22) PCT Filed: Jun. 19, 2018
(86) PCT No.: PCT/JP2018/023237

§ 371 Date: Dec. 20, 2019

(30) Foreign Application Priority Data
Jun. 21, 2017 (JP) 2017-120991

(51) Int. Cl. H04L 29/06; H04L 12/66; H04L 29/08

(52) U.S. Cl. CPC H04L 69/08; H04L 69/324; H04L 65/104; H04L 12/66

(57) ABSTRACT

A protocol conversion apparatus is provided between a public switched telephone network using the common channel signaling system and an IP network. The protocol conversion apparatus comprises a protocol conversion part that mutually converts an MTP2 message at layer 2 of the public switched telephone network and an M2PA message at layer 2 of the IP network with respect to a message exchanged between the public switched telephone network and the IP network.

### REFERENCE TO RELATED APPLICATION

This application is a National Stage of International Application No. PCT/JP2018/023237 filed Jun. 19, 2018, claiming the benefit of the priority of Japanese patent application No. 2017-120991 filed on Jun. 21, 2017, the disclosure of which is incorporated herein in its entirety by reference thereto.

### FIELD

The present disclosure relates to a protocol conversion apparatus, message relay method, and program, and particularly to a protocol conversion apparatus, message relay method, and program that interconnect a public switched telephone network (PSTN) using the common channel signaling system and an IP (Internet Protocol) network.

### BACKGROUND

As part of all-IP implementation, a concept that abolishes the public switched telephone network (PSTN), which exchanges signaling messages using the common channel signaling system, and replaces it with an IP network that exchanges SIGTRAN signaling messages has been proposed. As apparatuses for connecting a public switched telephone network and an IP network, signaling gateway and IP signaling transfer point (IP-STP) are known. Similarly to the signaling gateway, the IP-STP performs protocol conversion with an STP (Signaling Transfer Point) provided in the public switched telephone network (PSTN). Note that the common channel signaling system refers to the Common Channel Signaling System No. 7, which is also called SS7, CCSS7, or C7 (CCITT Number 7).

Patent Literature (PTL) 1 discloses an example of a signaling gateway that routes signaling traffic via IP. FIG. 5 and paragraphs 0030-0031 of the document show a traffic flow when the signaling gateway of Patent Literature 1 is used.
[PTL 1]
Japanese Patent Kohyo Publication No. JP-P2004-533742A

### SUMMARY

The following analysis is given by the present disclosure. In the process of implementing all-IP, since the cost of using the public switched telephone network (PSTN) is high, there is a demand from telecommunications carriers to reduce the sections used. By providing the IP-STPs mentioned above, it is possible to reduce the sections of the public switched telephone network, but IP-STP apparatuses are expensive, and it is not practical to install them at several thousands of the potential locations nationwide.

The operation of an IP-STP will described with reference to FIG. 3. First, the IP-STP terminates the MTP3 (Message Transfer Part 3) protocol when converting it. Then, the IP-STP performs routing in the higher SCCP (Signaling Connection Control Part) layer and connects to other peer using the MTP3 protocol again. The signaling gateway of Patent Literature 1 behaves in the same manner.

Having the IP-STP or STP terminate the signal as described above means that the public switched telephone network (PSTN) and the IP network (SIGTRAN network) perform separate instances of communication, requiring advanced software. This increases the cost of the IP-STP.

It is an object of the present disclosure to provide a protocol conversion apparatus, message relay method, and program that can contribute to reducing the cost of connecting a public switched telephone network (PSTN) and an IP network.

According to a first aspect, there is provided a protocol conversion apparatus provided between a public switched telephone network using the common channel signaling system and an IP network, and comprising a protocol conversion part that mutually converts an MTP2 message at layer 2 of the public switched telephone network and an M2PA message at layer 2 of the IP network with respect to a message exchanged between the public switched telephone network and the IP network.

According to a second aspect, there is provided a message relay method for a protocol conversion apparatus provided between a public switched telephone network using the common channel signaling system and an IP network, and including extracting an MTP2 message at layer 2 from a message received from the public switched telephone network side and converting the MTP2 message into an M2PA message at layer 2; and transmitting the converted M2PA message at layer 2 to the IP network side.

According to a third aspect, there is provided a message relay method for a protocol conversion apparatus provided between a public switched telephone network using the common channel signaling system and an IP network, and including extracting an M2PA message at layer 2 from a message received from the IP network side and converting the M2PA message into an MTP2 message at layer 2; and transmitting the converted MTP2 message at layer 2 to the public switched telephone network side. The message relay method is tied to a particular machine, namely, a protocol conversion apparatus provided between a public switched telephone network using the common channel signaling system and an IP network.

According to a fourth aspect, there is provided a computer program for realizing the functions of the protocol conversion apparatus. Further, this program may be stored in a computer-readable (non-transient) storage medium. In other words, the present disclosure can be realized as a computer program product.

The meritorious effects of the present disclosure are summarized as follows.

According to the present disclosure, it becomes possible to reduce the cost of connecting a public switched telephone network (PSTN) and an IP network. In other words, the present disclosure converts the apparatus described in Background into an apparatus capable of further contributing to the reduction of the cost of connecting a public switched telephone network (PSTN) and an IP network.

### BRIEF DESCRIPTION OF DRAWINGS

FIG. 1 is a drawing illustrating the configuration of an exemplary embodiment of the present disclosure.

FIG. 2 is a drawing for explaining a scheme in which a STP and an IP-STP are directly connected.

FIG. 3 is a drawing for explaining the operation of a scheme in which a STP and an IP-STP are directly connected.

FIG. 4 is a drawing illustrating the configuration of a first exemplary embodiment of the present disclosure.

FIG. 5 is a functional block diagram illustrating the logical configuration of an MTPC according to the first exemplary embodiment of the present disclosure.

FIG. 6 is a drawing showing a message flow in the MTPC according to the first exemplary embodiment of the present disclosure.

FIG. 7 is a drawing showing the format of MSU exchanged between a STP and the MTPC according to the first exemplary embodiment of the present disclosure.

FIG. 8 is a drawing showing the format of LSSU exchanged between the STP and the MTPC according to the first exemplary embodiment of the present disclosure.

FIG. 9 is a drawing showing the format of FISU exchanged between the STP and the MTPC according to the first exemplary embodiment of the present disclosure.

FIG. 10 is a drawing for explaining the contents of fields in each signal unit shown in FIGS. 7 to 9.

FIG. 11 is a detailed sequence diagram showing an operation (link establishment) of the first exemplary embodiment of the present disclosure.

FIG. 12 is a detailed sequence diagram showing an operation (normal sequence after a link has been established) of the first exemplary embodiment of the present disclosure.

FIG. 13 is a detailed sequence diagram showing an operation (alive monitoring) of the first exemplary embodiment of the present disclosure.

FIG. 14 is a detailed sequence diagram showing an operation (when a link failure is detected) of the first exemplary embodiment of the present disclosure.

FIG. 15 is a drawing illustrating the configuration of a computer constituting the protocol conversion apparatus of the present disclosure.

### PREFERRED MODES

First, an outline of an exemplary embodiment of the present disclosure will be described with reference to the drawings. Note that drawing reference signs in the outline are given to each element as an example solely to facilitate understanding for convenience and are not intended to limit the present disclosure to the aspects shown in the drawings. Further, connection lines between blocks in the drawings referred to in the description below can be both bidirectional and unidirectional. Unidirectional arrows schematically indicate main flows of signals (data) and do not exclude bidirectionality. In addition, although each input/output connection point of each block in the drawings has a port or interface, this is omitted.

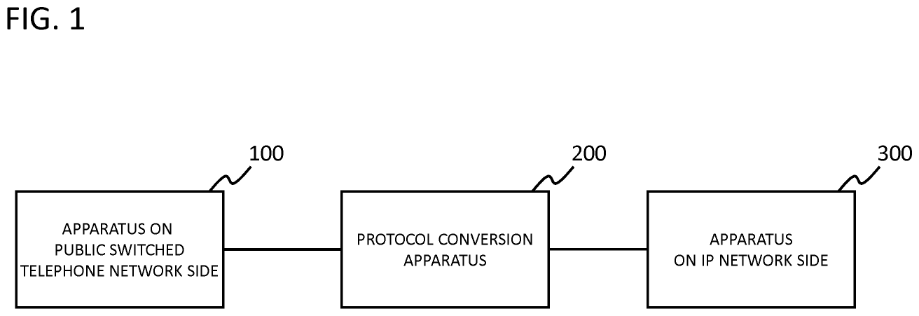

The present disclosure in an exemplary embodiment thereof can be realized by a protocol conversion apparatus 200 provided between a public switched telephone network using the common channel signaling system and an IP network as shown in FIG. 1. More specifically, this protocol conversion apparatus 200 comprises a protocol conversion part that mutually converts MTP2 messages at layer 2 of the public switched telephone network and M2PA (Message Transfer Part 2 Peer-to-Peer Adaptation Layer) messages at layer 2 of the IP network with respect to messages exchanged between an apparatus 100 on the public switched telephone network side, represented by the STP described above, and an apparatus 300 on the IP network side, represented by the IP-STP described above.

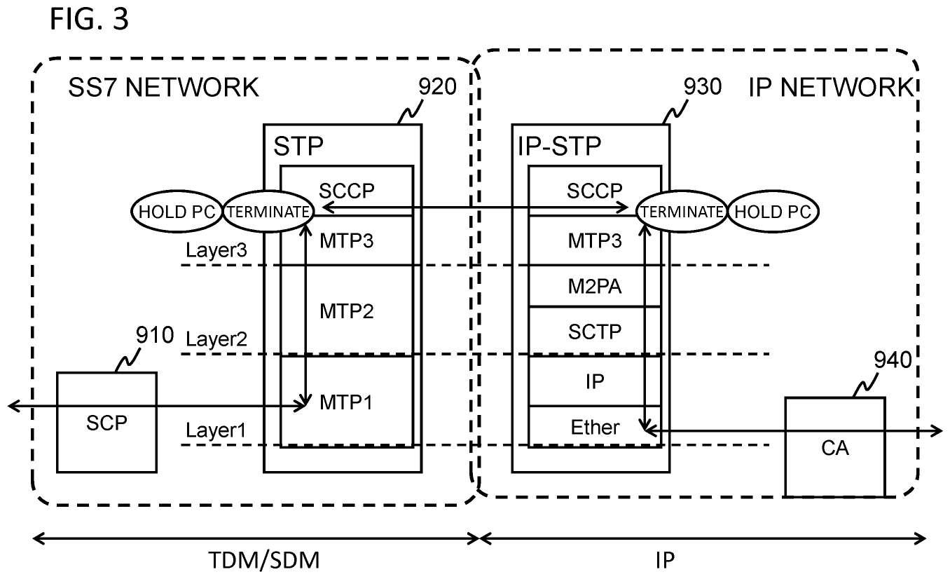

The protocol conversion apparatus 200 performs protocol conversion at layer 2 when signal stations of the public switched telephone network and the IP network exchanges messages. As a result, it is not necessary to terminate a signal at layer 3 of the STP and perform routing at the higher SCCP layer as shown in FIG. 3. This eliminates the necessity to install a complex application on each apparatus, reducing the cost of connecting the public switched telephone network (PSTN) and the IP network.

### First Exemplary Embodiment

Next, a first exemplary embodiment of the present disclosure will be described in detail with reference to the drawings. First, as a reference example, a configuration and the operation thereof will be described in a case where direct protocol conversion is performed between a STP in a public switched telephone network using the common channel signaling system (referred to as “SS7 network” hereinafter) and an IP-STP in an IP network. The operation will be described.

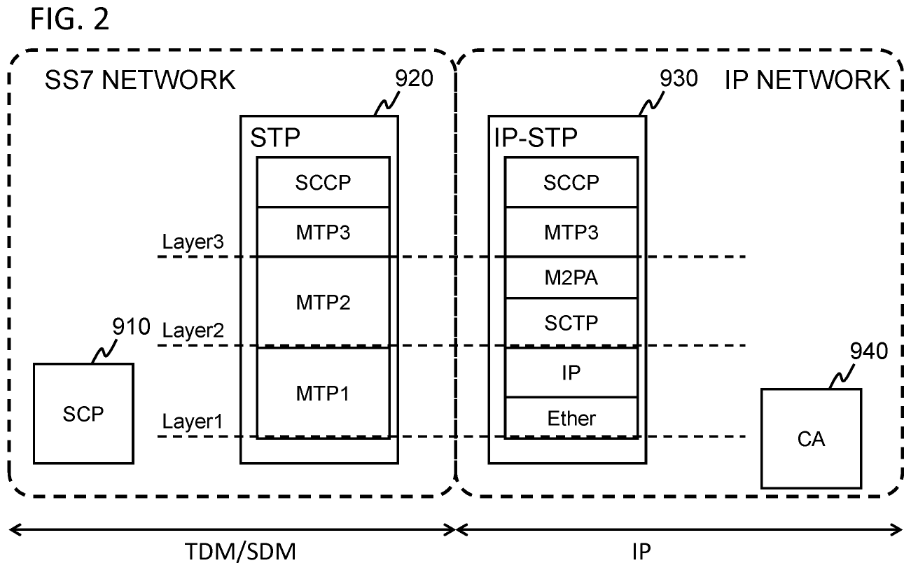

FIG. 2 is a drawing for explaining the scheme in which the STP and the IP-STP are directly connected. The IP-STP 930 in FIG. 2 functions as a gateway that performs protocol conversion to absorb the protocol differences between the SS7 network and the IP network. In FIG. 2, MTP is a generic term for protocols corresponding to signaling layers 1 to 3, and is an abbreviation for a message transfer part. MTP1 (layer 1) functions as a signal data link part, MTP2 (layer 2) a signaling link function part, and MTP3 (layer 3) a signal network function part. Further, in FIG. 2, an SCP 910 is an abbreviation for a service control point, and a CA 940 is an abbreviation for a call agent.

As shown in FIG. 3, the STP 920 and the IP-STP 930 confirm the destination and then perform routing after confirming up to MTP3 in the signal in order to forward a message to the designated destination. More specifically, the STP 920 and the IP-STP 930 refer to the OPC (Originating Point Code) and DPC (Destination Point Code) of MTP3 to confirm the designated destination. Then, after obtaining the information on the OPC and DPC (collectively referred to as PC (Point Codes) hereinafter), the message is forwarded.

In the message forwarding at layer 3, it is necessary to perform protocol conversion into M3UA (MTP3 User Adaptation Layer) and carry out message routing after holding the confirmed PC.

Further, the SS7 network and the IP network use different protocols for one-to-one communication between switches in each network. The former uses MTP2 and the latter M2PA. Since the STP 920 and the IP-STP 930 perform different types of communication, it is necessary to terminate the signal once when performing protocol conversion in MTP3 as described above. Due to this termination, the STP 920 and the IP-STP 930 both need a buffer. In addition, the STP 920 and the IP-STP 930 will need to be aware of the protocol of the counterpart apparatus thereof, requiring advanced software development and increasing the cost.

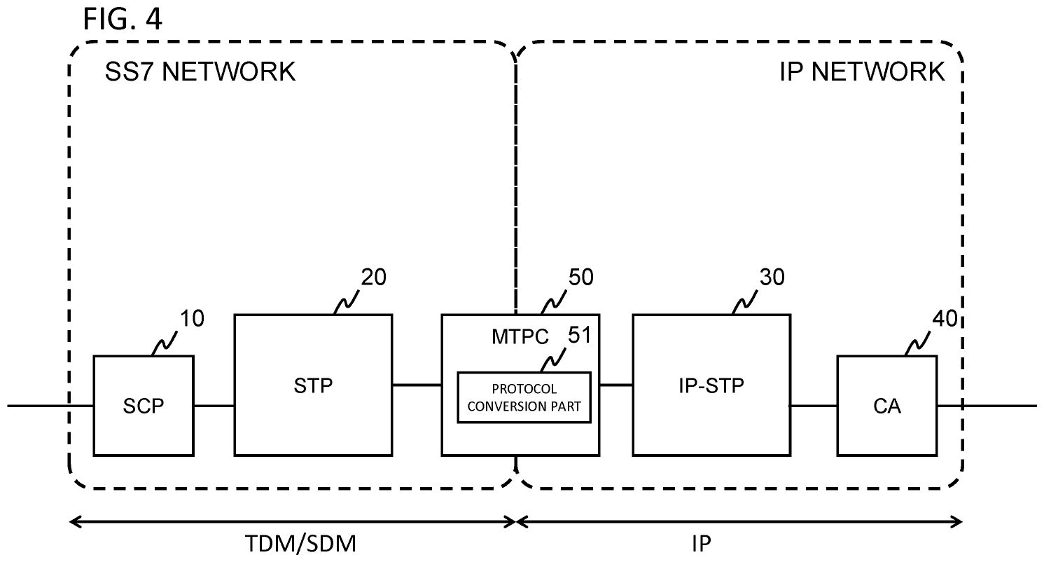

FIG. 4 is a drawing illustrating the configuration of the first exemplary embodiment of the present disclosure. The first exemplary embodiment of the present disclosure employs the following configuration in order to reduce cost compared with the reference example. With reference to FIG. 4, an MTPC (MTP Converter) 50 corresponding to the protocol conversion apparatus described above is provided between the SS7 network and the IP network. Further, the following description assumes that an SCP 10 and a STP 20 are provided in the SS7 network and an IP-STP 30 and a CA 40 are provided in the IP network.

The MTPC 50 comprises a protocol conversion part 51 that absorbs the differences between the SS7 and IP protocols, and performs MTP2 protocol conversion. Further, the protocol conversion part 51 performs protocol conversion at layer 2 without terminating the signal when a message is exchanged between a node in the IP network and a node in the SS7 network. This eliminates the need for the confirmation up to layer 3 and the PC holding discussed in the reference example. Further, since it is not necessary for the STP to terminate the signal and perform routing, a complex application does not have to be installed thereon. The following describes the configuration of the MTPC 50 in detail.

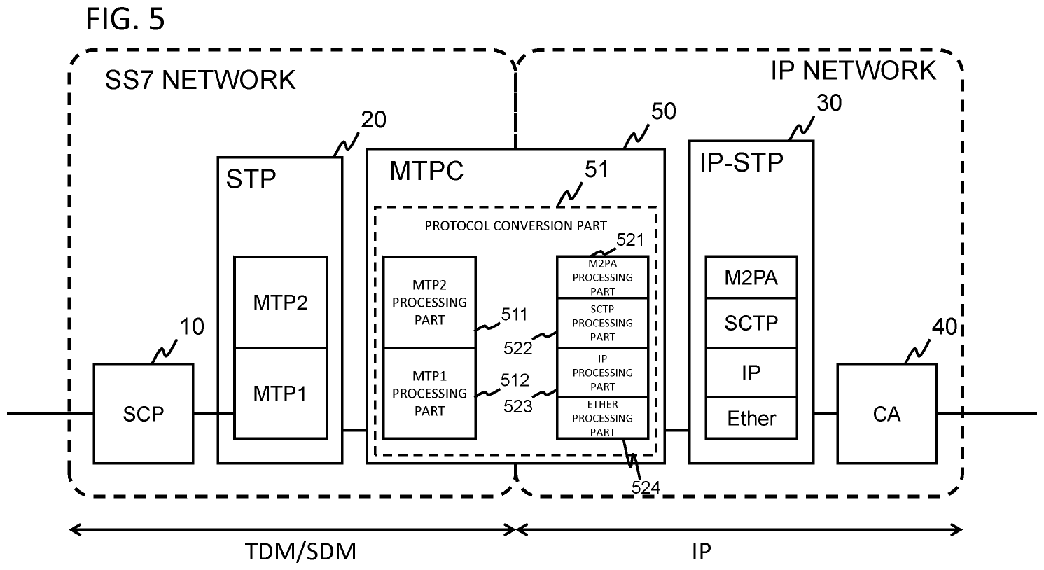

FIG. 5 is a functional block diagram illustrating the logical configuration of the MTPC 50. With reference to FIG. 5, the protocol conversion part 51 within the MTPC 50 comprises an MTP1 processing part 512 serving as an interface to the SS7 network side, and an MTP2 processing part 511. Further, the protocol conversion part 51 comprises an Ether processing part 524 serving as an interface to the IP network side, an IP processing part 523, an SCTP (Stream Control Transmission Protocol) processing part 522, and an M2PA processing part 521.

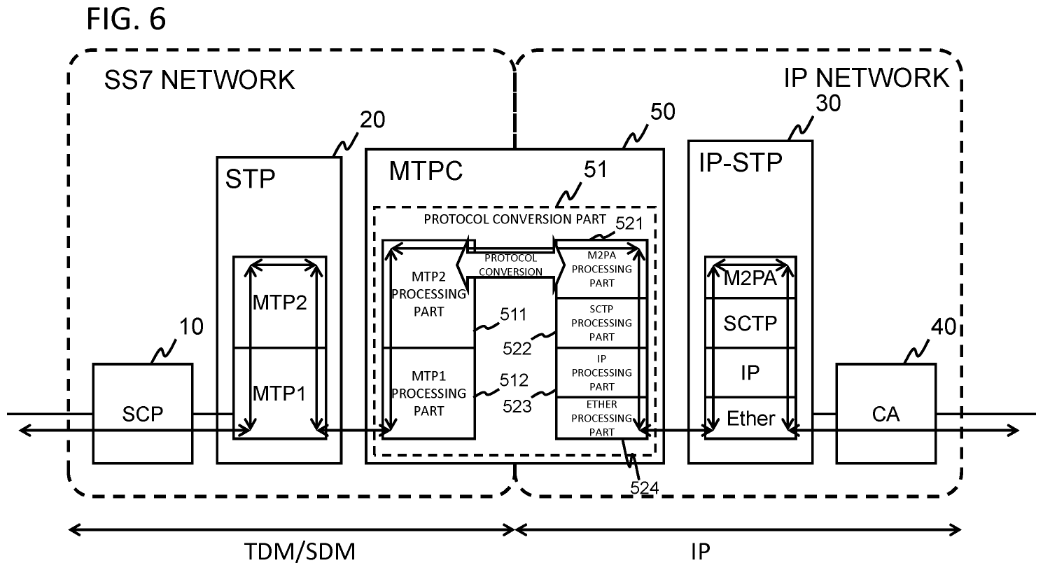

FIG. 6 is a drawing showing a message flow in the MTPC 50. The following describes the flow of a message received from the SS7 network and destined for the IP network. The MTP1 processing part 512 in layer 1 of the MTPC 50 on the SS7 network side receives the message transmitted from the STP 20 in the SS7 network. The MTP1 processing part 512 sends the received message to the MTP2 processing part 511. The MTP2 processing part 511 extracts the MTP2 message from the message sent from the MTP1 processing part 512 and converts it into an M2PA message at layer 2 on the IP network side. The MTP2 processing part 511 sends the converted M2PA message to the M2PA processing part 521. As described later, an MTP2 message and an M2PA message can be converted into each other because one-to-one assignment is possible.

The M2PA message received by the M2PA processing part 521 is transmitted to the IP-STP 30 in the IP network via the SCTP processing part 522, the IP processing part 523, and the Ether processing part 524.

Conversely, the following describes the flow of a message received from the IP network and destined for the SS7 network. The Ether processing part 524 in layer 1 of the MTPC 50 on the IP network side receives the message from the IP-STP 30 in the IP network. The Ether processing part 524 extracts the body of the received message and sends it to the IP processing part 523. The IP processing part 523 extracts the body of the received message and sends it to the SCTP processing part 522. The SCTP processing part 522 extracts the body of the received message and sends it to the M2PA processing part 521. The M2PA processing part 521 extracts the M2PA message from the message sent from the SCTP processing part 522 and converts it into an MTP2 message at layer 2 on the SS7 network side. The M2PA processing part 521 sends the converted MTP2 message to the MTP2 processing part 511.

The MTP2 message received by the MTP2 processing part 511 is transmitted to the STP 20 in the SS7 network via the MTP1 processing part 512.

Each part (processing means) of the MTPC 50 shown in FIGS. 5 and 6 can also be realized by a computer program that causes a processor installed in the MTPC 50 to execute each processing described above using the hardware thereof.

### [Delivery Confirmation Using Sequence Numbers]

In the present exemplary embodiment, it is more desirable that the following process be performed at the time of protocol conversion at layer 2. When a message is relayed between the SS7 and IP networks, the sequence number in the message can be used for end-to-end delivery confirmation of the link. Therefore, in the present exemplary embodiment, the STP 20 in the SS7 network and the IP-STP 30 in the IP network are able to confirm delivery.

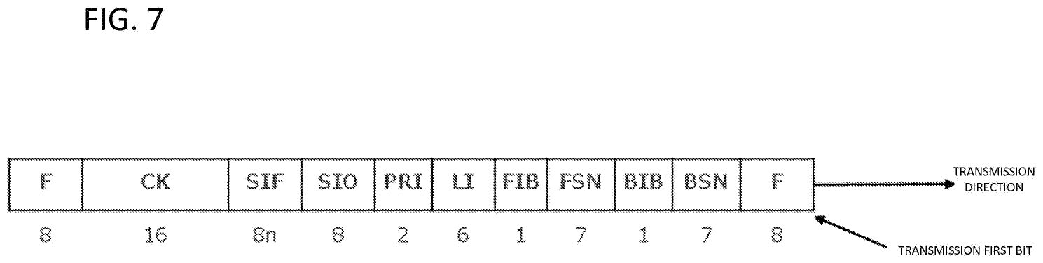

The format of the MTP2 message will be described with reference to FIGS. 7 to 10. Fields are provided in the format of the MTP2 message, but the message format is slightly different for each signal unit.

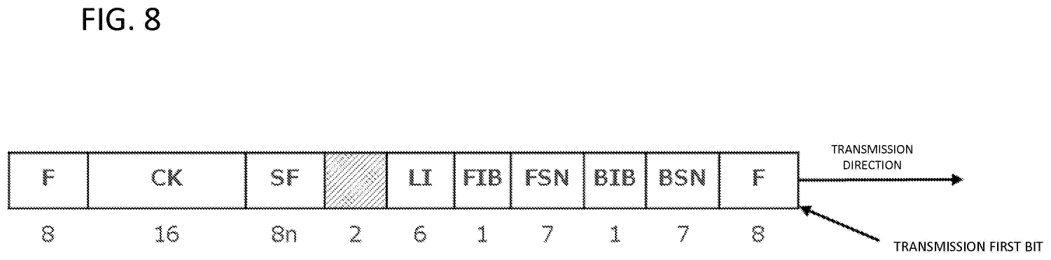

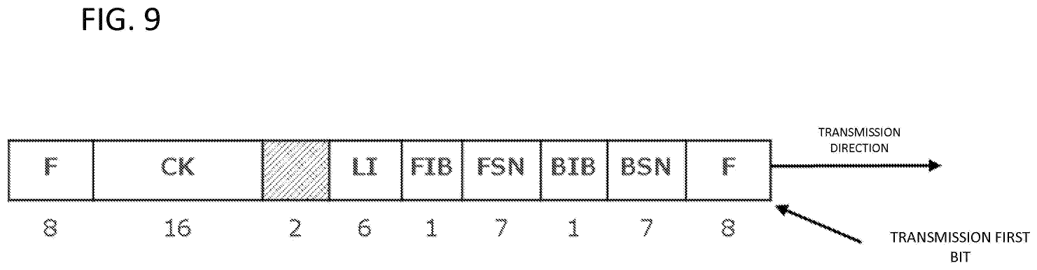

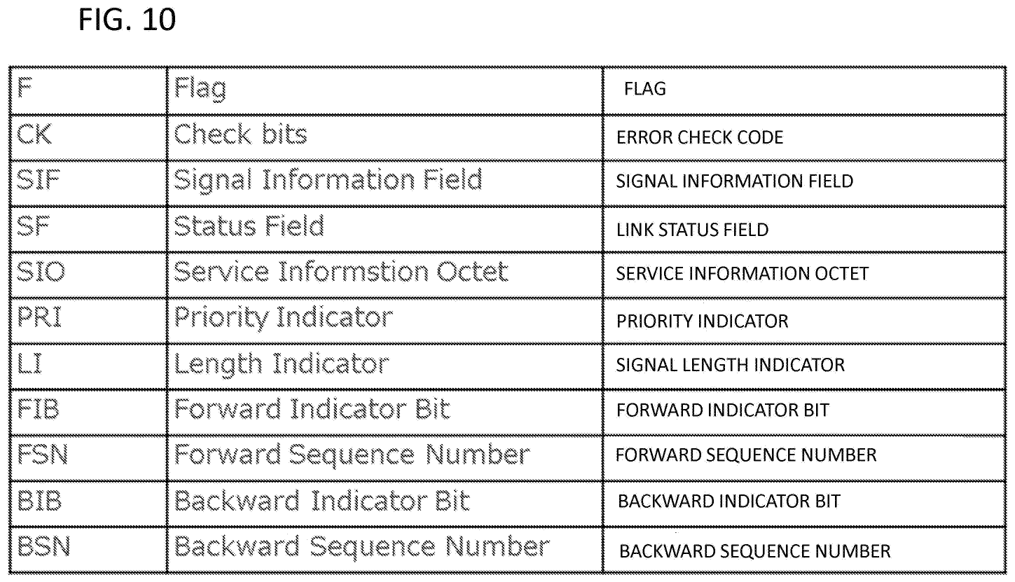

FIG. 7 shows the format of MSU (Message Signal Unit), one of the signal units. FIG. 8 shows the format of LSSU (Link Status Signal Unit), another signal unit. FIG. 9 shows the format of FISU (Fill In Signal Unit), yet another signal unit. FIG. 10 is a drawing for explaining the contents of each field in FIGS. 7 to 9.

The signal formats of MTP2 in FIGS. 7 to 9 have a field called FSN (Forward Sequence Number). The sequence number of a transmitted signal unit is set in this field. The present exemplary embodiment allows sequence numbers from 0 to 127. Meanwhile, BSN (Backward Sequence Number) indicates the sequence number of a received signal unit returned as a response, and this also allows numbers from 0 to 127.

This conforms to the ITU-T Q.700 series recommendations defining that the sequence numbers of transmitted MTP2 signal units should be within a range of 0 to 127. These recommendations, however, expand the range of the sequence numbers of M2PA at layer 2 in the IP network to 0 to 65535 (Note that RFC4165 defines that the M2PA sequence numbers range from 0 to 16,777,215). Therefore, the number of sequence numbers differs between MTP2 and M2PA.

When performing mapping conversion of sequence numbers in protocol conversion by the MTPC 50, the M2PA processing part 521 performs mapping conversion while limiting the range of sequence numbers to 0 to 127, including the IP-STP 30, which is the counterpart apparatus on the IP network side. Further, in the present exemplary embodiment, the M2PA side cannot utilize a line bandwidth beyond that of 64 kbps to 48 kbps on the MTP2 side.

In order to examine the merits of the sequence number limits, we will assume a hypothetical case where the limits of sequence numbers are not matched between M2PA and MTP2. In this case, when a message is received, the MTPC 50 has to confirm deliveries between the apparatuses on the M2PA side (between the IP-STP 30 and the MTPC 50) and between the MTPC 50 and the STP 20. This means that the MTPC 50 terminates the signal at layer 2 and requires a buffer.

On the other hand, the present exemplary embodiment has the advantages that the MTPC 50 does not require a buffer and sequence numbers do not have to be mapped since the MTPC 50 does not terminate layer 2 communication. These advantages are not limited to the omission of buffer and have a secondary effect that the influence on the SS7 and IP networks is minimized and the existing resources can be utilized to the maximum extent.

Next, a specific operation in the MTPC 50 of the present exemplary embodiment will be described. When the reference example is compared with the present exemplary embodiment, the differences between them can be summarized in the following two points.
The MTPC is provided between the STP in the SS7 network and the IP-STP in the IP network in the present exemplary embodiment.
Confirmation up to layer 3 and references to the OPC/DPC ensure accurate forwarding and these point codes (PC) are held in the reference example. Further, communication is terminated once since no protocol conversion is involved. The present exemplary embodiment, however, confirms up to layer 2, performs protocol conversion and does not terminate communication, and therefore each network is not aware of the protocol differences.

Next, a specific operation of layer 2 conversion in the MTPC 50 of the present exemplary embodiment will be described using a sequence diagram. In the following description, conversion examples of the following operations will be described.
(1) Link Establishment
(2) Link Establishment & Simple Mapping
(3) Alive Monitoring
(4) Link Failure Detection

### (1) Link Establishment

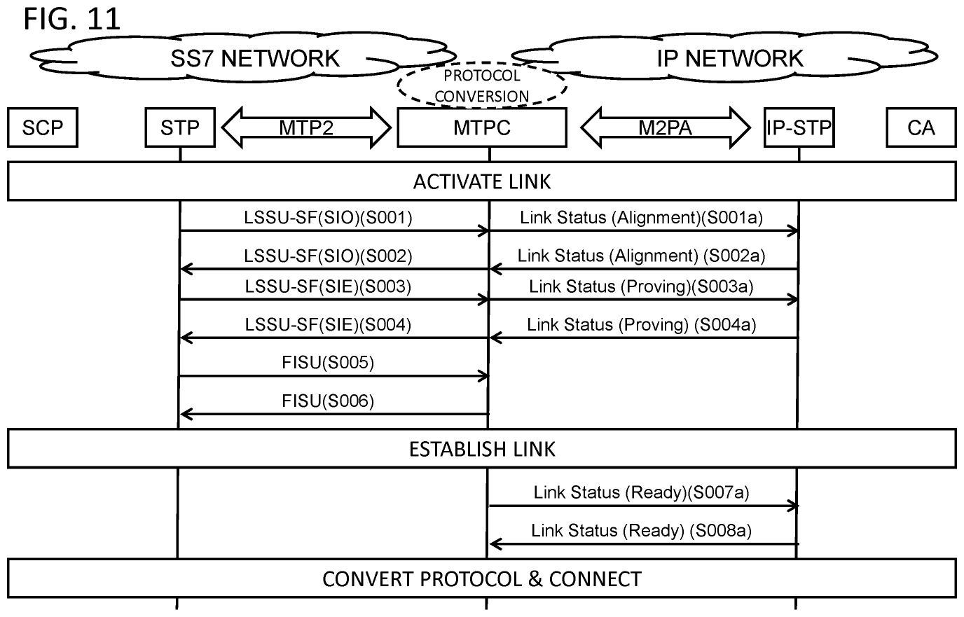

FIG. 11 shows a sequence when a link is established between nodes in the SS7 and IP networks. First, to establish a signaling link, a signaling link initial setting procedure is performed, and this is carried out with the counterpart station in order to operate a new link or a link where a failure is detected. The initial setting procedure is applied only to signaling links to be initialized and is set in the status field (SF) of the link status signal unit (LSSU).

Confirm Link Status

First the link status is confirmed. In FIG. 11, when the STP 20 in the SS7 network activates a link, a message having SIO (Status Indication “Out of alignment”) set in LSSU of MTP2 is transmitted to the MTPC 50 (step S001). This SIO message is sent when a signaling link is activated and neither SIO nor SIE is received.

The MTPC 50 then performs conversion into M2PA, i.e., converting SIO into Link Status Alignment, and transmits the converted message to the IP-STP 30 in the IP network (step S001a). The IP-STP 30 confirms the activation of the signaling link, and replies Link Status (Alignment) to the MTPC 50 once the link establishment is approved (step S002a). The MTPC 50 converts the received M2PA message into an MTP2 message and transmits an LSSU with SIO to the STP 20 (step S002).

Link Status Verification

After confirming the link status between nodes specified in SF of the LSSU (Link Status Signal Unit) of the MTP2 message received from the MTPC 50, the STP 20 establishes a link. Next, the STP 20 transmits a message having SIE set in SF (Status Field) (step S003). Note that SIE (Status Indication “Emergency alignment”) is sent when SIO or SIE is received after a signaling link is activated.

Having received the LSSU-SF (SIO), the MTPC 50 converts SIE into Link Status (Proving) in order to convert the received message into an M2PA message, and transmits the converted message to the IP-STP 30 (step S003a). The IP-STP 30 confirms link establishment and then returns Link Status (Proving) to the MTPC 50 (step S004a). The MTPC 50 converts the received M2PA message into an MTP2 message and transmits an LSSU with SIE to the STP 20 (step S004).

Here, since the signaling link is normal, the STP 20 sends a FISU (refer to FIG. 9) to the MTPC 50 (step S005). FISUs are transmitted on a regular basis, and the MTPC 50 returns a FISU to the STP 20 (step S006).

In this state, protocol conversion and link establishment at layer 2 have been performed, however, due to the reception of the FISU from the STP 20, the MTPC 50 exchanges Link Status (Ready) with the IP-STP 30 in order to notify the IP-STP 30 on the M2PA side that the link has been established (steps S007a and S008a).

### (2) Link Establishment & Simple Mapping

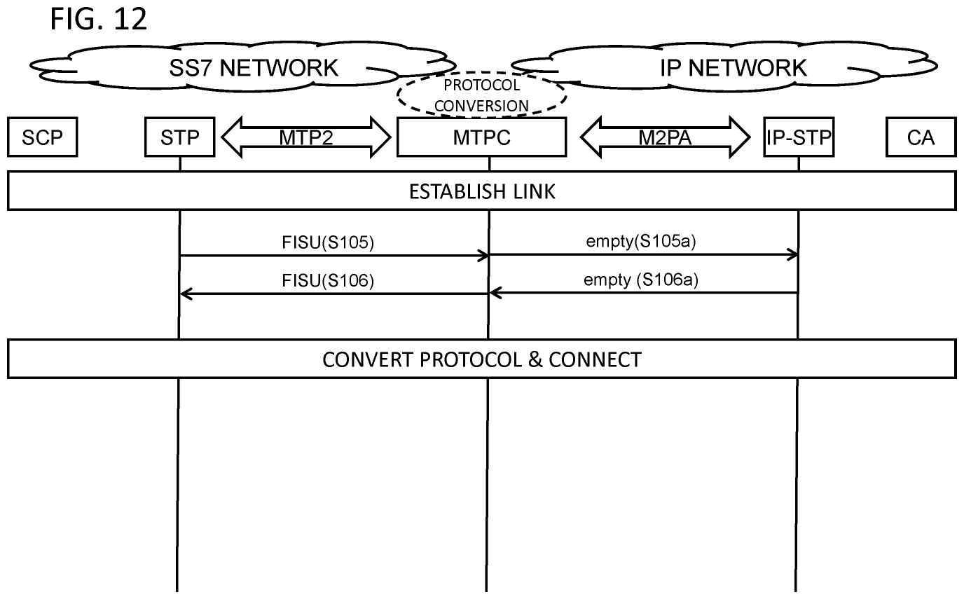

FIG. 12 shows a sequence when a link has been established between nodes in the SS7 and IP networks and only layer 2 conversion is performed.

The STP 20 transmits a FISU to the MTPC 50 (step S105). The MTPC 50 converts the FISU into an M2PA. Since a link has been already established in the present example, the MTPC 50 transmits an empty message to the IP-STP 30 (step S105a).

After confirming that a link has been established, the IP-STP 30 transmits an empty message to the MTPC 50 (step S106a), and the MTPC 50 converts it into an MTP2 message and transmits a FISU to the STP 20 (step S106).

In this process, FISU/empty mapping as a sequence number is performed.

### (3) Alive Monitoring

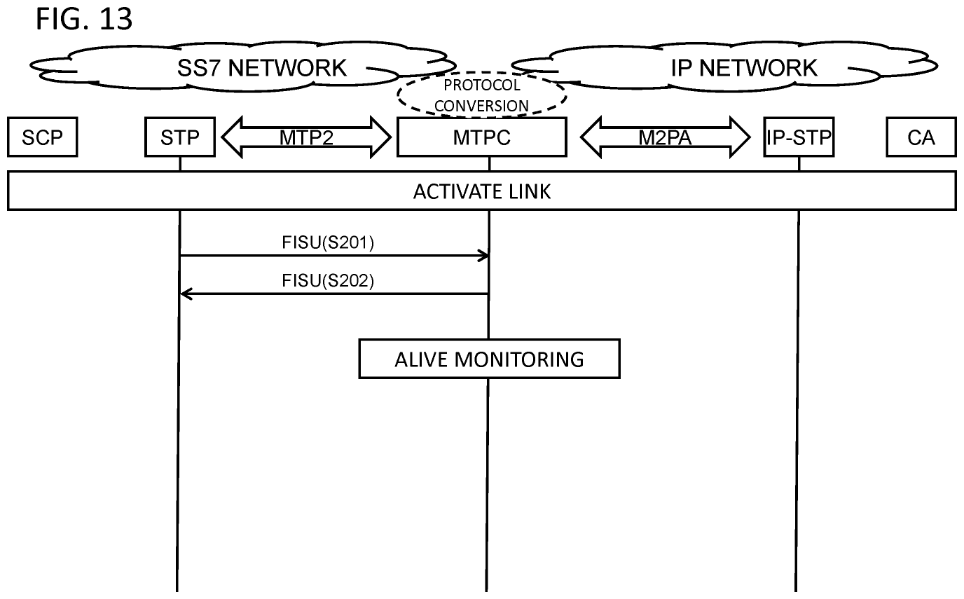

FIG. 13 shows a sequence when a link has been established between nodes in the SS7 and IP networks and alive monitoring on the counterpart apparatus is performed. As described above, the STP 20 transmits FISUs to the MTPC 50 at a predetermined cycle, and the MTPC 50 returns FISUs (steps S201 and S202). The MTPC 50 performs independent control without performing conversion into M2PA messages. Note that, in the example of FIG. 13, a different node performs alive monitoring on the M2PA side.

### (4) Link Failure Detection

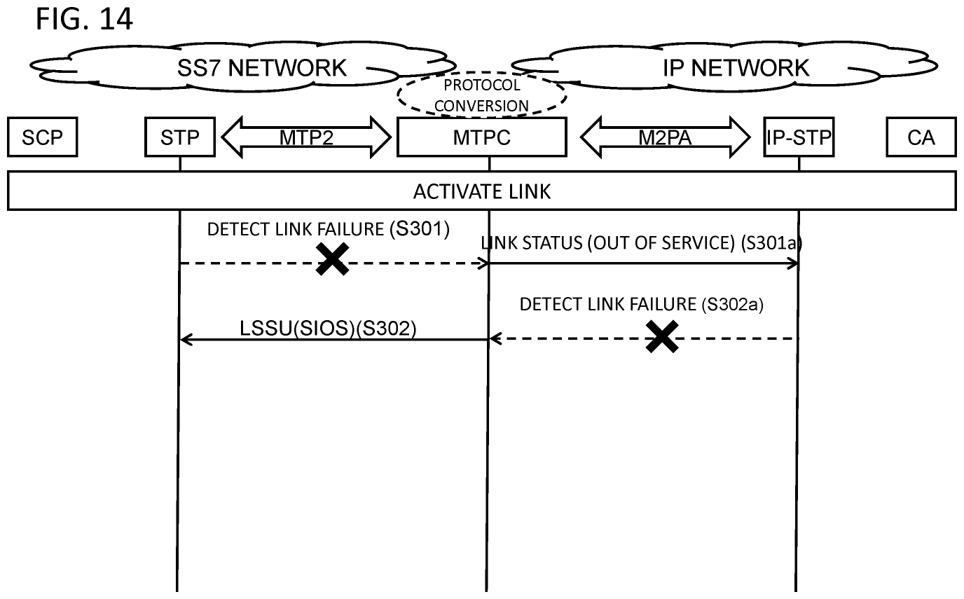

FIG. 14 shows a sequence when a failure has occurred between the STP 20 and the MTPC 50 or between the MTPC 50 and the IP-STP 30.

When detecting failure of the link to the STP 20, the MTPC 50 notifies the IP-STP 30 of the link failure. Specifically, when detecting failure of the link to the STP 20, the MTPC 50 transmits an M2PA Link Status (Out of Service) message to the IP-STP 30 (step S301a).

Further, when detecting failure of the link to the IP-STP 30, the MTPC 50 transmits an MTP2 message (LSSU SIOS) to the STP 20 (step S302). Note that SIOS is an abbreviation of Status Indication “Out of Service,” and is transmitted when a node wants to notify a communication partner node that the node is unable to transmit or receive any signal.

Finally, the effects derived from the present exemplary embodiment will be summarized. When protocol conversion apparatuses or signaling gateways are provided nationwide for all-IP implementations, two methods may be considered: installing IP-STPs as described in the reference example and installing the MTPCs of the present exemplary embodiment. The method that utilizes the MTPC of the present exemplary embodiment is superior in the following two points.

Buffer Reduction on Each Apparatus

The IP-STP and the STP in the reference example perform conversion and terminate communication at layer 3, however, the MTPC of the present exemplary embodiment does not terminate communication. By performing layer 2 conversion, the MTPC implements communication on a one-to-one basis without terminating it. For example, communication at layer 3 is intercepted between the IP-STP and STP apparatuses in the reference example, and each apparatus must terminate the communication once and hold the sequence numbers. When a link failure occurs, the sequence numbers that have arrived with MTP3 COO/COA/XCO/XCA signals must be notified in the reference example, and in order to do this, each apparatus must capture the MTP3 signals and the contents thereof must be rewritten.

On the other hand, the MTPC of the present exemplary embodiment has the advantage that it performs layer 2 conversion without rewriting sequence numbers, eliminating the need to have a buffer.

Cost Advantages in All-IP Implementations

As described above, the MTPC of the present exemplary embodiment has a simple configuration and can be developed at a low cost. In general, software that performs processing at a lower layer, having a simpler structure, is less costly than software that performs processing at a higher layer. Along with the buffer requirement mentioned in the first advantage paragraphs, the configuration of software becomes more complex as it starts to deal with higher layers, resulting in more costly software development.

The MTPC of the present exemplary embodiment, by contrast, adopts a scheme that pays attention to a lower layer, does not require costly development, and does not hold a buffer. This makes it possible to provide a less expensive product than the IP-STP of the reference example. When TDM sections are reduced and SIGTRAN networks are strengthened for all-IP implementations, it is more advantageous to place the MTPCs nationwide than the IP-STPs in terms of cost. More specifically, connecting SS7 and IP networks using the IP-STPs of the reference example for all-IP implementations will require thousands of IP-STPs installed nationwide. This is theoretically possible, but the installation and development costs will be high.

In contrast, by using the MTPC according to the present exemplary embodiment for all-IP implementations, it is possible to greatly reduce the costs of development, installation, construction, and maintenance. Moreover, the difference becomes more prominent as MTPCs are installed nationwide and the installation quantity increases. In addition, by using the MTPC according to the present exemplary embodiment, it becomes possible to meet the demand from telecommunications carriers to reduce TDM sections.

While each exemplary embodiment of the present disclosure has been described, it is to be understood that the present disclosure is not limited to the exemplary embodiment above and that further modifications, replacements, and adjustments may be added without departing from the basic technical concept of the present disclosure. For instance, the network configuration, the configuration of each element, and the expression of each message shown in each drawing are examples to facilitate understanding of the present disclosure and are not limited to the configurations shown in the drawings.

Further, in the exemplary embodiment described above, it is assumed that the public switched telephone network is an SS7 (Common Channel Signaling System No. 7) network, however, other common channel signaling systems may be used. Further, in the exemplary embodiment described above, MTP2 and M2PA messages are mutually converted, but it goes without saying that derived protocols and successor protocols thereof are also included.

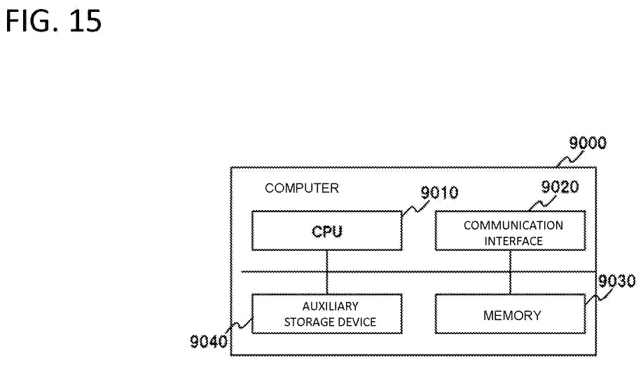

Further, the exemplary embodiment described above can be realized by a program that causes a computer (9000 in FIG. 15) functioning as a protocol conversion apparatus to realize the function as the protocol conversion apparatus. Such a computer is illustrated by a configuration comprising a CPU (Central Processing Unit) 9010, a communication interface 9020, a memory 9030, and an auxiliary storage device 9040 in FIG. 15. In other words, the CPU 9010 in FIG. 15 may execute a message reception program and a protocol conversion program, and update each calculation parameter held in the auxiliary storage device 9040 thereof.

Finally, preferred modes of the present disclosure are summarized as follows.

### [Mode 1]

(Refer to the protocol conversion apparatus according to the first aspect.)

### [Mode 2]

It is preferred that the protocol conversion part of the protocol conversion apparatus perform protocol conversion without terminating communication between the public switched telephone network and the IP network.

### [Mode 3]

It is preferred that the protocol conversion apparatus be provided between a STP on the public switched telephone network side and an IP-STP on the IP network side.

### [Mode 4]

It is preferred that the protocol conversion apparatus further comprise a function of performing alive monitoring on a link by exchanging a predetermined message with the STP on the public switched telephone network side.

### [Mode 5]

It is preferred that the protocol conversion apparatus further comprise a function of, when detecting failure of a link to one of the STP on the public switched telephone network side and the IP-STP on the IP network side, notifying the other apparatus of the link failure.

### [Mode 6]

(Refer to the message relay method according to the second aspect.)

### [Mode 7]

(Refer to the message relay method according to the third aspect.)

### [Mode 8]

(Refer to the program according to the fourth aspect.)

Further, Modes 6 to 8 above can be developed into Modes 2 to 5 as Mode 1.

Further, the disclosure of each Patent Literature cited above is incorporated herein in its entirety by reference thereto. It is to be noted that it is possible to modify or adjust the exemplary embodiments or examples within the whole disclosure of the present disclosure (including the Claims) and based on the basic technical concept thereof. Further, it is possible to variously combine or select (or partially delete) a wide variety of the disclosed elements (including the individual elements of the individual claims, the individual elements of the individual exemplary embodiments and examples, and the individual elements of the individual figures) within the scope of the disclosure of the present disclosure. That is, it is self-explanatory that the present disclosure includes any types of variations and modifications to be done by a skilled person according to the whole disclosure including the Claims, and the technical concept of the present disclosure. Particularly, any numerical ranges disclosed herein should be interpreted that any intermediate values or subranges falling within the disclosed ranges are also concretely disclosed even without specific recital thereof.

### REFERENCE SIGNS LIST

10, 910: SCP
20, 920: STP
30, 930: IP-STP
40, 940: CA
50: MTPC (MTP Converter)
51: protocol conversion part
100: apparatus on the public switched telephone network side
200: protocol conversion apparatus
300: apparatus on the IP network side
511: MTP2 processing part
512: MTP1 processing part
521: M2PA processing part
522: SCTP processing part
523: IP processing part
524: Ether processing part
930: IP-STP

What is claimed is:

1. A protocol conversion apparatus provided between a public switched telephone network using a common channel signaling system and an IP network, the protocol conversion apparatus comprising:
a protocol conversion part configured to mutually converts an MTP2 message at layer 2 of the public switched telephone network and an M2PA message at layer 2 of the IP network with respect to a message exchanged between the public switched telephone network and the IP network.

2. The protocol conversion apparatus according to claim 1, wherein the protocol conversion part performs protocol conversion without terminating communication between the public switched telephone network and the IP network.

3. The protocol conversion apparatus according to claim 1 provided between a Signaling Transfer Point STP on the public switched telephone network side and an IP-STP on the IP network side.

4. The protocol conversion apparatus according to claim 1 further comprising a function of performing alive monitoring on a link by exchanging a predetermined message with a Signaling Transfer Point STP on the public switched telephone network side.

5. The protocol conversion apparatus according to claim 1, when detecting failure of a link to one of Signaling Transfer Points STP on the public switched telephone network side and the IP-STP on the IP network side, further notifying the other apparatus of the link failure.

6. A message relay method for a protocol conversion apparatus provided between a public switched telephone network using the common channel signaling system and an IP network, the method comprising:
extracting an MTP2 message at layer 2 from a message received from the public switched telephone network side and converting the MTP2 message into an M2PA message at layer 2; and
transmitting the converted M2PA message at layer 2 to the IP network side.

7. A message relay method for a protocol conversion apparatus provided between a public switched telephone network using the common channel signaling system and an IP network, the method comprising:
extracting an M2PA message at layer 2 from a message received from the IP network side and converting the M2PA message into an MTP2 message at layer 2; and
transmitting the converted MTP2 message at layer 2 to the public switched telephone network side.

8.-9. (canceled)

10. The protocol conversion apparatus according to claim 2 provided between a Signaling Transfer Point STP on the public switched telephone network side and an IP-STP on the IP network side.

11. The protocol conversion apparatus according to claim 2 further comprising a function of performing alive monitoring on a link by exchanging a predetermined message with a Signaling Transfer Point STP on the public switched telephone network side.

12. The protocol conversion apparatus according to claim 3 further comprising a function of performing alive monitoring on a link by exchanging a predetermined message with a Signaling Transfer Point STP on the public switched telephone network side.

13. The protocol conversion apparatus according to claim 2, when detecting failure of a link to one of Signaling Transfer Points STP on the public switched telephone network side and the IP-STP on the IP network side, further notifying the other apparatus of the link failure.

14. The protocol conversion apparatus according to claim 3, when detecting failure of a link to one of Signaling Transfer Points STP on the public switched telephone network side and the IP-STP on the IP network side, further notifying the other apparatus of the link failure.

15. The protocol conversion apparatus according to claim 4, when detecting failure of a link to one of Signaling Transfer Points STP on the public switched telephone network side and the IP-STP on the IP network side, further notifying the other apparatus of the link failure.

16. The message relay method according to claim 6, wherein the protocol conversion is performed without terminating communication between the public switched telephone network and the IP network.

17. The message relay method according to claim 6, wherein the message relay method further comprising performing alive monitoring on a link by exchanging a predetermined message with a Signaling Transfer Point STP on the public switched telephone network side.

18. The message relay method according to claim 6, wherein the message relay method further comprising notifying the other apparatus of the link failure when detecting failure of a link to one of Signaling Transfer Points STP on the public switched telephone network side and the IP-STP on the IP network side.

19. The message relay method according to claim 7, wherein the protocol conversion is performed without terminating communication between the public switched telephone network and the IP network.

20. The message relay method according to claim 7, wherein the message relay method further comprising performing alive monitoring on a link by exchanging a predetermined message with a Signaling Transfer Point STP on the public switched telephone network side.

21. The message relay method according to claim 7, wherein the message relay method further comprising notifying the other apparatus of the link failure when detecting failure of a link to one of Signaling Transfer Points STP on the public switched telephone network side and the IP-STP on the IP network side.
